(19) United States
(12) Patent Application Publication
(10) Pub. No.: US 2012/0150995 A1
(43) Pub. Date: Jun. 14, 2012

(54) TRANSFER APPARATUS, MESSAGE TRANSFER SYSTEM, MESSAGE TRANSFER METHOD, AND PROGRAM

(75) Inventor: Makoto Kunimatsu, Soka-shi (JP)

(73) Assignee: CANON KABUSHIKI KAISHA, Tokyo (JP)

(21) Appl. No.: 13/310,534

(22) Filed: Dec. 2, 2011

(30) Foreign Application Priority Data
Dec. 8, 2010 (JP) 2010-273906

(51) Int. Cl. G06F 15/16

(52) U.S. Cl. 709/217

(57) ABSTRACT

A technique for transferring a plurality of messages to the same client includes registering one or more clients used by a user and determining a client to which a received message is to be transferred from among the registered clients.

### BACKGROUND OF THE INVENTION

1. Field of the Invention

The present invention relates to a message transfer apparatus, a message transfer system, a message transfer method, and a program.

2. Description of the Related Art

In recent years, it has become popular to connect a plurality of electronic devices to each other via a network and transmit/receive data among them. It has also become popular for a single user to simultaneously use a plurality of electronic devices connected via a network.

For use in a situation in which a single user uses a plurality of client devices (hereinafter also referred to as clients), a technique has been proposed to select a client to which to transfer a message addressed to the user.

For example, in a conventional message system, a server has data stored therein in terms of the priority of clients, presence states of clients in terms of whether clients can receive messages, and status in terms of usage of media, such as text data, audio data, video data, etc., in each client. The information on the priority and other items described above stored in the server is updated as required depending on the status of each client.

If the server receives a message addressed to a user using a plurality of clients, the server gets information on the priority and the like for all clients used by the user. The server selects a client that is the highest in priority among those clients which are in a presence state in which message can be received and in a state in which any of medium possessed by the clients is not being used, and the server determines the selected client as a client to which the received message is to be transferred (see for example, Japanese Patent Laid-Open No. 2004-153352).

In the conventional message system, after a first message addressed to a user using a plurality of clients is transmitted, if a second message addressed to the same user is transmitted, these two messages are treated as follows.

Based on the information indicating the priority or the like as of a time at which the first message was received, the server selects a client to which the first message is to be transferred. Similarly, as for the second message, based on the information indicating the priority or the like as of a time at which the second message was received, the server selects a client to which the second message is to be transferred (hereinafter such a selected client to which a message is to be transferred will be also referred to as a transfer destination client or a transfer destination).

Therefore, in the conventional technique, if the information indicating the priority or the like, according to which the transfer destination is selected, is changed before the second message is received after the reception of the first message, the first and second messages can be transferred to different clients.

However, when the second message is related to the first message, if the two messages are transferred to different clients, a problem can occur.

For example, when a first user is using a plurality of digital cameras, if a second user wants to remotely control one the plurality of digital cameras via a network to capture an image and transmit image data captured by this camera to the first user, an operation is likely to be performed as follows: the second user operates a client terminal to transmit data as a first message including an image capture command and data as a second message including an image transmission command.

If the information associated with the priority or the like used to determine message transfer destinations is changed before the server receives the second message after the reception of the first message, the image capture command and the image transmission command can be transmitted to different clients.

If the image capture command and the image transmission command are transmitted to different clients, it becomes impossible for the second user to attain his/her object.

Thus, there is a need for a technique that allows transferring the second message to the same client as that to which the first message is transferred even in a case where the client selection priority is changed after the reception of the first message before the reception of the second message.

### SUMMARY OF THE INVENTION

In view of the above, the present invention provides a technique that allows it to transfer a plurality of messages to the same client regardless of a change in priority.

In an aspect, the present invention provides a transfer apparatus configured to transfer a message to a client such that when the transfer apparatus receives a message transmitted from a first client and addressed to a destination designated by identification information of a user using one or more clients, a second client to which the received message is to be transferred is determined by selecting one of the clients used by the user corresponding to the identification information to which the message is addressed. The transfer apparatus includes a memory and a processing unit, wherein the processing unit registers one or more clients used by the user, determines a client to which the received message is to be transferred such that in a case where a plurality of clients used by the user corresponding to the identification information to which the received message is addressed are included in the registered clients, one of the clients used by the user is selected as the client to which the received message is to be transferred, wherein when a first message assigned with an identifier and addressed to the identification information of the user using the plurality of clients is received, processing unit stores data indicating the determined client as a client to which the first message is to be transferred in the memory, and wherein when a second message is received, if the second message is assigned with an identifier corresponding to the identifier assigned to the first message addressed to the identification information and if the second message is addressed to the identification information of the user using the plurality of clients, the processing unit determines the client indicated by the data stored in the memory as a client to which the second message is to be transferred.

Thus, the present invention makes it possible to transfer a plurality of messages used as a whole for a particular purpose to the same client.

Further features of the present invention will become apparent from the following description of exemplary embodiments with reference to the attached drawings.

### BRIEF DESCRIPTION OF THE DRAWINGS

FIG. 1 is a diagram illustrating a message transfer system according to an embodiment of the present invention.

FIG. 2A is a diagram illustrating a configuration of a server according to an embodiment of the present invention.

FIG. 2B is a diagram illustrating a configuration of a client according to an embodiment of the present invention.

FIG. 3A is a diagram illustrating a configuration of program modules executed by a client according to an embodiment of the present invention.

FIG. 3B is a diagram illustrating a configuration of program modules executed by a server according to an embodiment of the present invention.

FIG. 4 is a sequence diagram illustrating an operation of a message transfer system according to an embodiment of the present invention.

FIG. 5A is a diagram illustrating priority data in a state before being updated according to an embodiment of the present invention.

FIG. 5B is a diagram illustrating priority data updated according to an embodiment of the present invention.

FIG. 6A is a diagram illustrating an example of a message set according to an embodiment of the present invention.

FIG. 6B is a diagram illustrating details of messages transmitted, according to an embodiment of the present invention.

FIG. 7 is a flow chart illustrating a message set management process performed by a client according to an embodiment of the present invention.

FIG. 8 is a flow chart illustrating a message set management process performed by a server according to an embodiment of the present invention.

FIG. 9A is a diagram illustrating an example of a table in which transfer destination data is described by a server according to an embodiment of the present invention.

FIG. 9B is a diagram illustrating an example of transfer destination data described by a server according to an embodiment of the present invention.

FIG. 10 is a flow chart illustrating a monitoring routine performed by a server according to an embodiment of the present invention.

### DESCRIPTION OF THE EMBODIMENTS

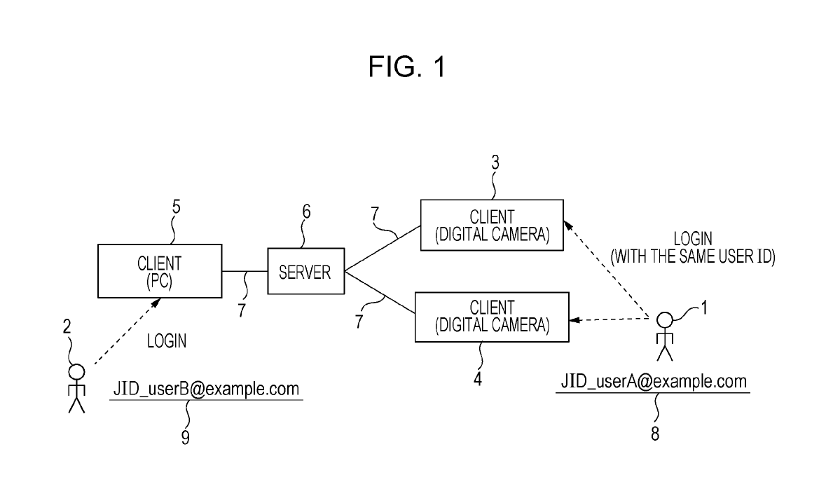

A configuration of a message system according to an exemplary embodiment of the present invention is described below with reference to FIG. 1. In FIG. 1, a client 3, a client 4, and a client 5 are connected to a server 6 via a network 7. In the present embodiment, it is assumed by way of example that the client 3 and the client 4 are digital cameras, and the client 5 is a personal computer (hereinafter referred to as a PC). Note that the clients are not limited to PCs or digital cameras, and the clients may be other electronic devices (apparatuses) such as a Personal Digital Assistant (PDA), a portable telephone, a portable music player, a home game machine, a printer, etc.

In the present embodiment, as shown in FIG. 1, it is also assumed that there are two users, i.e., a user 1 and a user 2. User 1 is using two devices (apparatuses), more specifically, the client 3 and the client 4. The user 2 is using the client 5. In the message system according to the present embodiment, “JID userA@example.com” is set as identification information (user ID) of the user 1. Similarly, “JID userB@example.com” is set as identification information (user ID) of the user 2. These user IDs are registered in a memory 22, as described below, of the server 6 by the transmission unit 51.

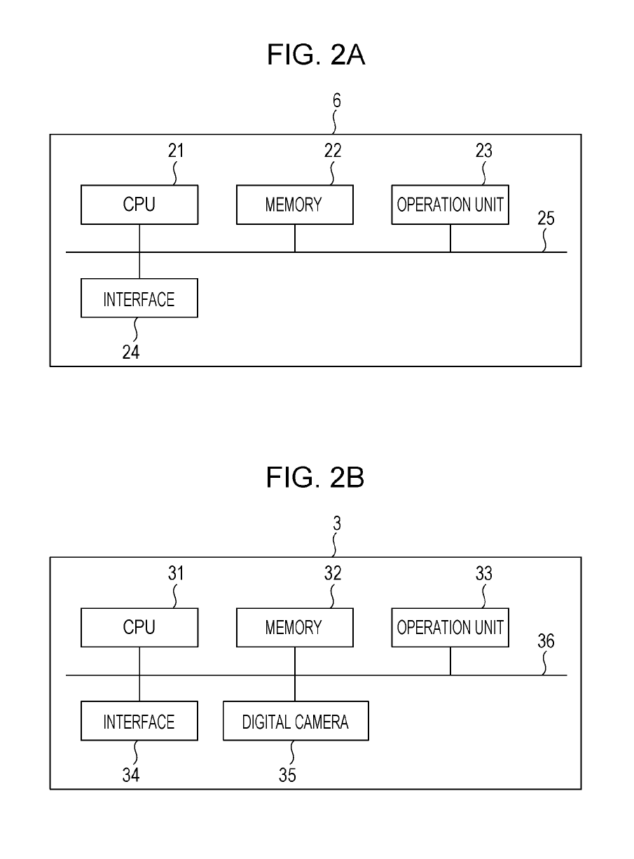

Next, a configuration of the server 6 will be described below with reference to FIG. 2A. In the server 6, a CPU 21, the memory 22, an operation unit 23, and an interface 24 are connected to each other via a bus 25. The CPU 21 is a central processing unit that reads out a program stored in the memory 22 and executes the program.

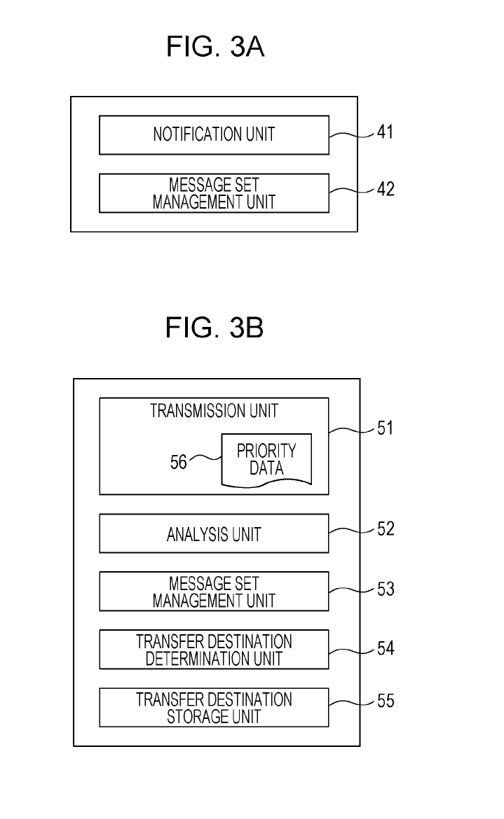

FIG. 3B illustrates a configuration of program modules stored in the memory 22. The transmission unit 51 is a program module that manages the status of each client and performs a message transmission process.

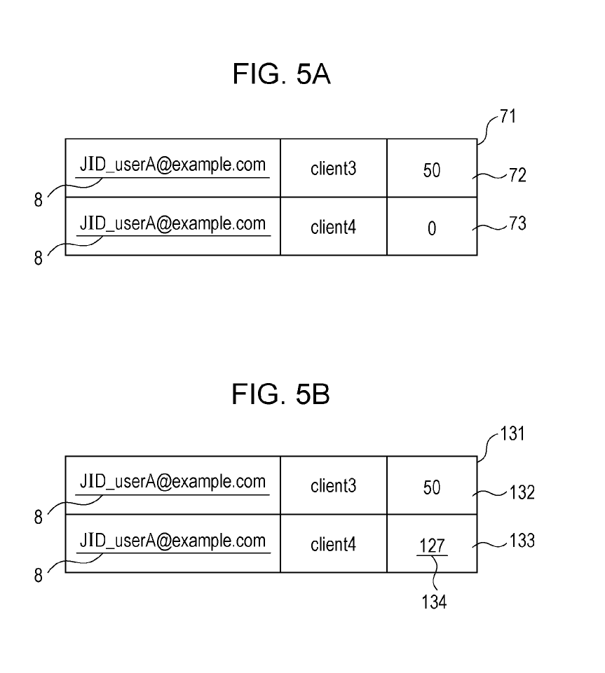

The transmission unit 51 uses priority data 56. The priority data 56 is data stored in the memory 22 (data cannot be stored in a software module)and is used by the transmission unit 51 to select a transfer destination of a message addressed to a user ID in a case where there are two or more clients corresponding to the same user ID. The details of the priority data 56 will be described later with reference to FIG. 5A. An analysis unit 52 is a program module that determines whether a received message belongs to a message set. The message set refers to a set of a plurality of messages used as a whole to perform a particular process. A transfer destination determination unit 54 is a program module that determines a client to which a message set is to be transferred, by selecting from one or more clients used by a user corresponding to identification information to which the message set is addressed. A transfer destination storage unit 55 is a program module that stores data indicating the transfer destination clients determined by the transfer destination determination unit 54 in relation to identifiers of message sets.

The interface 24 is connected to the network 7 to transmit/receive messages to/from clients. The operation unit 23 is used to operate the server 6. The operation unit 23 includes a display and an operation keyboard.

Next, a configuration of the client 3 is described below with reference to FIG. 2B. In the client 3, a CPU 31, a memory 32, an operation unit 33, an interface 34, and a camera unit 35 are connected to each other via a bus 36. The CPU 31 is a central processing unit that reads out a program stored in the memory 32 and executes it.

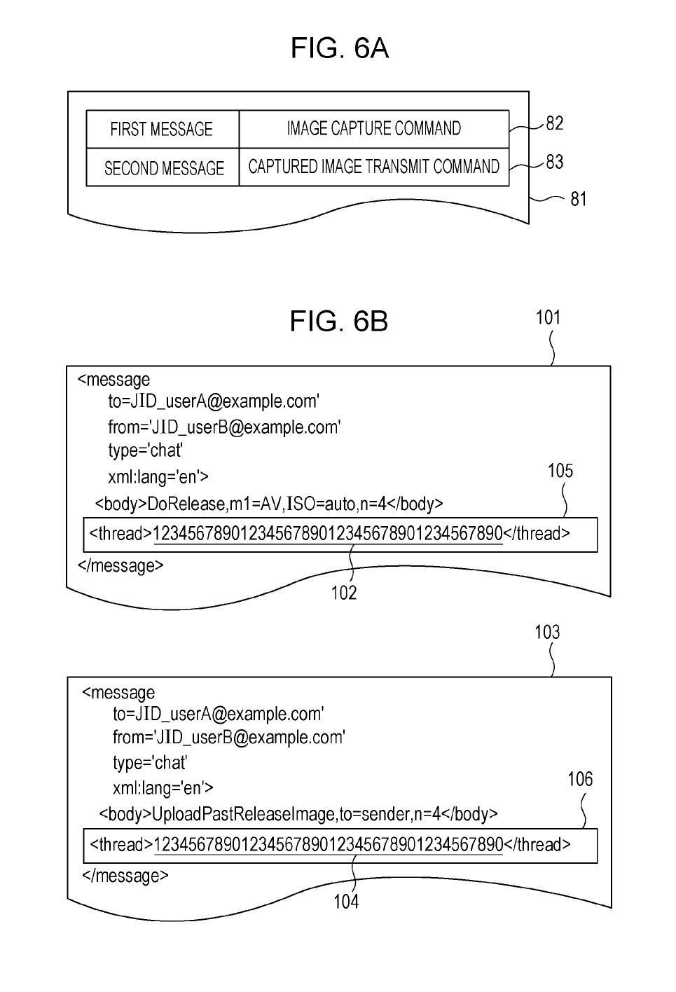

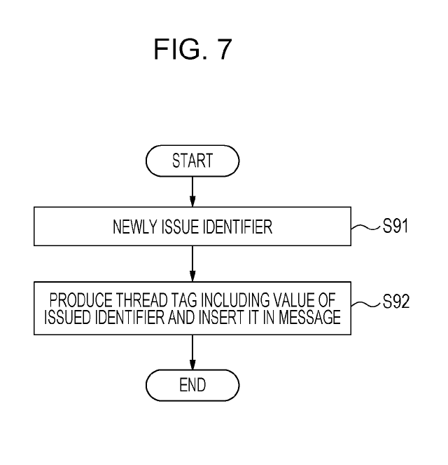

The memory 32 serves to store the program executed by the CPU 31. A configuration of program modules stored in the memory 32 is described below with reference to FIG. 3A. A notification unit 41 is a program module that performs a login notification process. The login notification process is a process that is performed, in response to a login to a client by a user, to send a login message from the client to the server to notify of the login. A message set management unit 42 is a program module that performs a message set management process. The message set management process is a process of assigning an identifier to each of messages used in executing a particular process thereby forming a set of messages (also referred to as a message set). An operation of the message set management unit 42 will be described later in detail with reference to FIG. 7 in conjunction with FIGS. 6A and 6B. Note that the processes performed by the program modules shown in FIG. 3A may be performed by hardware instead of by the program modules.

The interface 34 is connected to the network 7 to transmit/receive messages to/from the server 6. The operation unit 33 is used to operate the client 3. The operation unit 33 includes a display and an operation keyboard. In the present embodiment, the client 3 and the client 4 are digital cameras. The client 4 may be similar in configuration to the client 3. In the present embodiment, the client 5 is a PC (Personal Computer). The client 5 may be similar in configuration to the client 3 shown in FIG. 2B except that the client 5 does not have the camera unit 35.

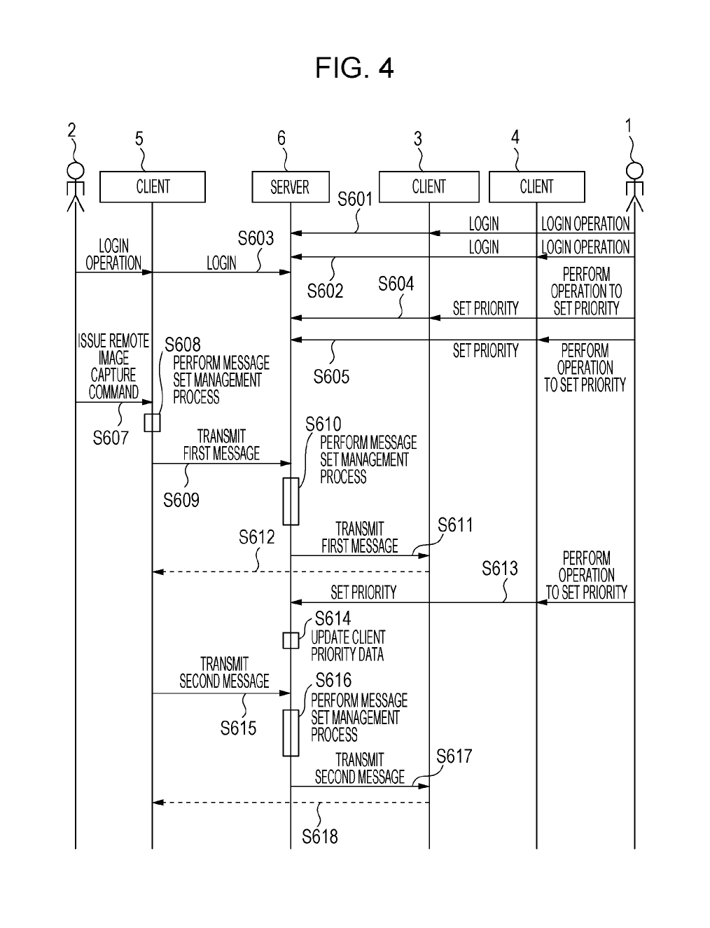

Next, an operation of a message system according to the present invention is described below with reference to an operation sequence diagram shown in FIG. 4.

First, in sequence step S601, a user 1 logs in to the client 3. If the user 1 logs in to the client 3, the notification unit 41 in the client 3 transmits a prescribed login message to the server 6. If the login message is received by the transmission unit 51 of the server 6, the transmission unit 51 stores information indicating that the client 3 has gone into a state where it is logged-in by the user 1. More specifically, the transmission unit 51 stores data indicating the client and identification information of the user logging in to the client, as shown in FIG. 5A. In sequence step S602, the user 1 also logs in to the client 4. Furthermore, in sequence step S603, the user 2 logs in to the client 5.

Next, in sequence step S604, the user 1 sets the server 6 in terms of the priority of the client 3. Furthermore, in sequence step S605 the user 1 sets the server 6 in terms of the priority of the client 4. The priority refers to a value used by the server 6 to determine which client a received message is to be transferred to. In the present embodiment, the priority can take an integer value in a range from −128 to +127. The greater the value, the higher the priority. A client having the highest priority is selected as a destination to which a message is to be transferred. FIG. 5A illustrates an example of a table 71 in which data is described to indicate the priority for each client being logged in. In the table 71 shown in FIG. 5A, a plurality of clients used by the user 1 to which the received message is addressed are registered. In a row 72 of the table 71, the priority of the client 3 is set to 50. Similarly, in a row 73, the priority of the client 4 is set to 0.

In a next sequence step S607, the user 2 performs a remote image capturing operation using the camera logged in by the user 1. The remote image capturing operation refers to an operation of remotely controlling a camera via a network to capture an image and acquiring the captured image data. In the present embodiment, the user 2 performs the remote image capturing operation by operating the client 5 to send messages such as those shown in FIG. 6A to the client 3 or the client 4 that is a digital camera.

That is, the client 5 transmits a first message 82 and a second message 83 shown in FIG. 6A to the client 3 or the client 4. The first message 82 is a message indicating that the release operation on the digital camera should be performed. In response to receiving the first message 82, the client 3 or the client 4 functioning as the digital camera performs a release operation. The second message 83 is a message indicating that the captured image data should be transmitted to a sender of the message. In response to receiving the second message 83, the client 3 or the client 4 functioning as the digital camera transmits the captured image obtained as a result of the immediately previous release operation to the client 5 that is the sender of the second message 83. Thus, in sequence step S607, the remote image capturing operation is performed by sequentially transmitting the first message 82 and the second message 83 to the digital camera as described above.

Next, in sequence step S608, the message set management unit 42 of the client 5 performs a message set management process. The message set management process refers to a process of assigning a common identifier to a plurality of messages used as a whole to perform a particular process thereby forming a set of messages (also referred to as a message set). The message set including the first message 82 and the second message 83 used in performing the remote image capturing operation is an example of a message set according to the present embodiment. That is, in FIG. 6A, reference numeral 81 denotes an example of a message set used to perform a remote image capturing operation.

The message set management process performed by the client 5 is described below with reference to a flow chart shown in FIG. 7. First, a message set management unit 42 newly generates an identifier (step S91). Next, the message set management unit 42 assigns a character string representing the identifier generated in step S91 to all messages belonging to the message set (hereinafter, referred to as member messages) (step S92). In the present embodiment, messages are transmitted using Extensible Messaging and Presence Protocol (XMPP) that is a real-time messaging protocol. The identifier generated in step S91 is described in the form of a character string in the messages using <thread> and </thread> tags defined in XMPP. Hereinafter, a pair of <thread> and </thread> tags will also be referred to as a “thread” tag pair. That is, if a message includes a “thread” tag pair, the message is one of member messages of a message set. Note that the tag pair used to indicate that a message is a member message of a message set is not limited to the “thread” tag pair, but other predetermined tags or a predetermined arbitrary character string may be used. In the present embodiment, the user 2 using the client 5 may define which messages are member messages of a message set. Note that member messages of a message set may be defined by other methods that enable practice of the present embodiment.

FIG. 6B illustrates examples of messages produced via the message set management process in sequence step S608. In the examples shown in FIG. 6B, a message 101 is obtained by assigning a character string 102 as an identifier to the first message 82, and a message 103 is obtained by assigning a character string 104 as an identifier to the second message 83.

The existence of identifiers in messages makes it possible for the server 6 to recognize that the messages belong to particular message sets. Furthermore, if identifiers existing in a plurality of messages are identical to each other, the server 6 recognizes that these messages are member messages belong to the same message set. Note that member messages refer to as individual messages belonging to a message set, as described earlier. For example, the first message 82 and the second message 83 are member messages of the message set 81 used to perform the remote image capturing operation. In the present embodiment, the character string 102 enclosed in a “thread” tag set 105 and the character string 104 enclosed in a “thread” tag set 106 are identifiers generated in step S91, and they are identical to each other. Note that the character strings 102 and 104 do not need to be identical to each other if it is possible to determine, at a receiving side, that the first message 82 and the second message 83 belong to the same message set. For example, a few least significant digits of each character string may be used to describe which one of the messages the message of interest is in the same message set.

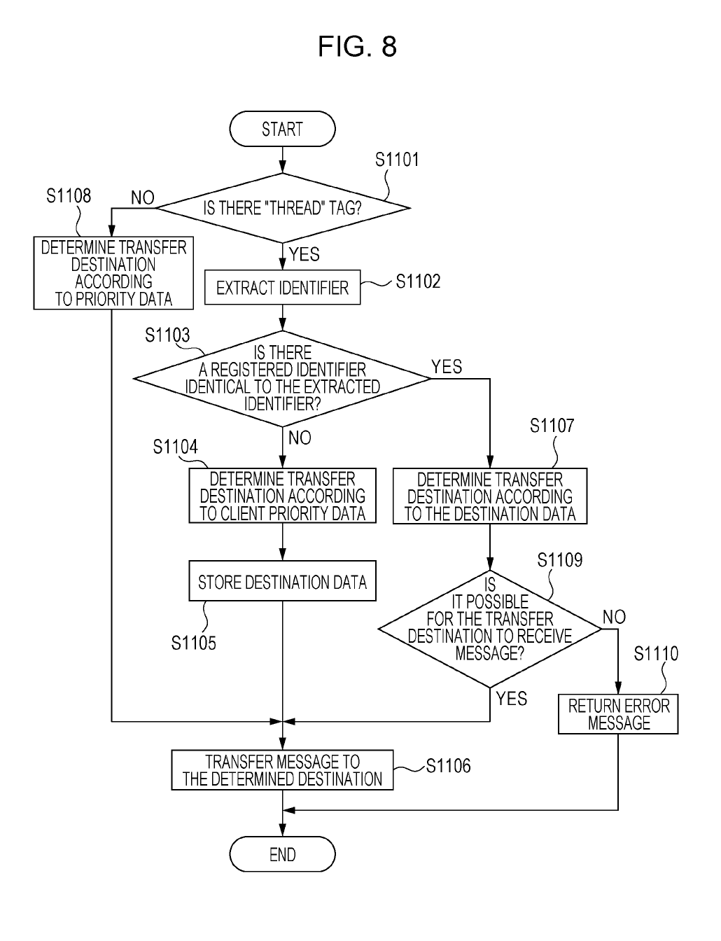

Next, in sequence step S609, the client 5 transmits the first message 101 to the server 6. The first message 101 is a message indicating that the release operation on the digital camera should be performed. If the server 6 receives the first message, the message set management unit 53 in the server 6 performs the message set management process (step S610). The message set management process in sequence step S610 is described in further detail below with reference to a flow chart shown in FIG. 8. Note that the process shown in the flow chart in FIG. 8 is performed by the CPU 21 by executing a program corresponding to the flow shown in FIG. 8.

First, the analysis unit 52 analyzes the content of the message received from the client 5 to determine whether the message includes a tag pair in which a character string indicating a message set is enclosed (step S1101). In the present embodiment, as shown in FIG. 6B, an identifier indicating a message set is put between <thread> and </thread> tags. Note that a pair of <thread> and </thread> tags is also referred to simply as a “thread” tag pair as described earlier. In the present embodiment, the analysis unit 52 determines whether the received message includes a “thread” tag pair to determine whether the received message belongs to a particular message set.

In a case where the received message includes a “thread” tag pair (that is, if the answer to step S1101 is YES), the process proceeds to step S1102 that will be described later. On the other hand, in a case where the received message does not include an identifier indicating a particular message set (that is, if the answer to step S1101 is NO), the transfer destination determination unit 54 determines a transfer destination client based on client priority data shown in FIG. 5A (step S1108). Thereafter, the process proceeds to step S1106 described below. The determination on the transfer destination client does not necessarily need to be based on the priority, but other factors such as presence states of clients or states of using media may be employed as selection criteria. Still alternatively, the determination as to the transfer destination client may be performed based on a total of many factors including the priority.

In step S1102, the transfer destination determination unit 54 extracts a value of the identifier indicating the message set from the received message. In the present example, the character string 102 is extracted as the identifier indicating the particular message set.

Next, the transfer destination determination unit 54 determines whether the identifier extracted in step S1102 is included in transfer destination data stored in the transfer destination storage unit 55 (step S1103). Note that the transfer destination data is data describing a message sender, an identifier indicating a message set to which the message belongs, and a destination of member messages belonging to the message set.

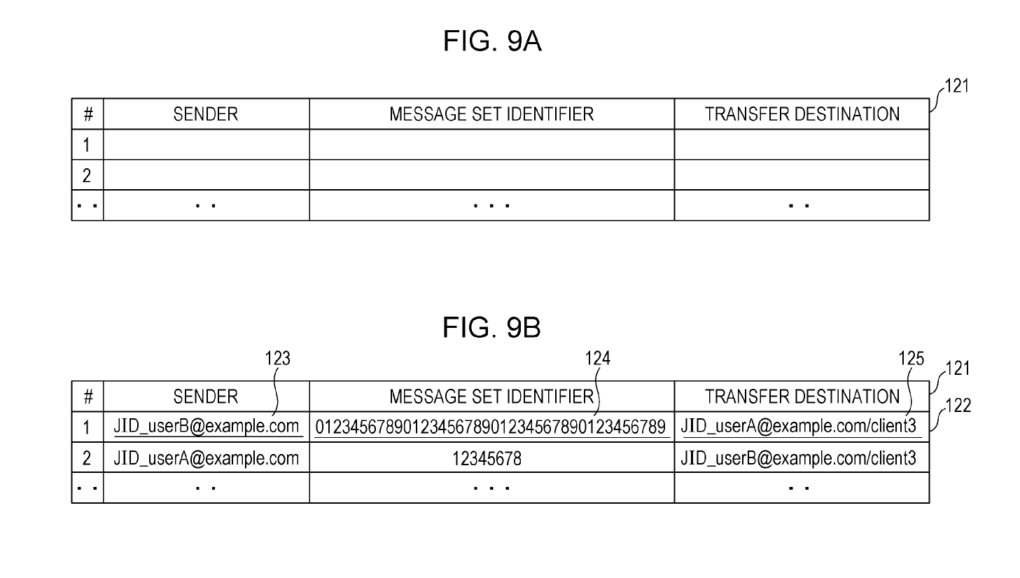

FIG. 9A illustrates an example of a table describing transfer destination data stored in the transfer destination storage unit 55. In the present example, it is assumed that at a point of time at which the first message is received, the transfer destination data does not include an identifier identical to the character string 102. Therefore, the transfer destination determination unit 54 makes a negative determination in step S1103, which causes the process to proceed to step S1104.

In step S1104, the transfer destination determination unit 54 of the server 6 selects a transfer destination of the first message 101 from a plurality of clients used by the user 1 according to the priority data 56. In the example shown in FIG. 5A, the client priority data indicates that the client 3 has the highest priority, and thus the client 3 is selected as the transfer destination of the message.

Next, the transfer destination storage unit 55 stores the transfer destination data including a data element indicating the identifier of the message set extracted in step S1102 and a data element indicating the transfer destination client for the first message determined in step S1104 (step S1105). FIG. 9B illustrates an example of transfer destination data stored in step S1105. In the example shown in FIG. 9B, a character string 123 is an identifier of the user 2 who is the sender of the first message 101. A character string 124 is the identifier of the first message 101 extracted in step S1102. A character string 125 is the identifier of the message destination client determined in step S1105.

After the transfer destination data is stored in step S1105, the transmission unit 51 transfers the first message 101 to the transfer destination client determined (step S1106). Thus, the message set management process in sequence step S610 is complete. Next, in sequence step S611, the server 6 transmits the first message 101 to the client 3. In a case where the answer to step S1103 in the message set management process shown in FIG. 8 is YES, the message set management process in sequence step S616 is performed in such a manner as described later.

Next, in sequence step S612, on receiving the first message 101 from the server 6, the client 3 returns a response to the client 5.

In the present embodiment, in a case where the priority of the client 4 is changed by the user 1 after the client 3 receives the first message 101, the process is performed as described below. If the user 1 performs an operation to change the priority of the client 4, sequence step S613 and sequence step S614 are performed. That is, in sequence step S613, the client 4 notifies the server 6 of the redefined priority. In response, in sequence step S614, the transmission unit 51 of the server 6 updates the priority data 56. FIG. 5B illustrates an example of priority data 131 obtained by updating the priority data 56 in sequence step S614. In the example shown in FIG. 5B, the priority of the client 4 in a row 133 has been rewritten such that the client 4 has the highest priority, and thus the message addressed to the user 1 is transferred to the client 4.

Subsequently, in sequence step S615, the client 5 transmits the second message 103 to the server 6. The second message 103 is a message indicating that the captured image data is to be transmitted to the sender of the message. If the server 6 receives the second message 103, then, in sequence step S616, the server 6 performs the message set management process in a similar manner as in sequence step S610 according to the flow chart shown in FIG. 8.

The message set management process in sequence step S616 is described in detail below with reference to the flow chart shown in FIG. 8. First, in step S1101, it is determined that the received second message 103 includes a “thread” tag pair, and thus the process proceeds to step S1102.

In step S1102, the transfer destination determination unit 54 extracts an identifier indicating a message set. In the present example, the character string 104 shown in FIG. 6B is extracted as the identifier indicating the message set. Next, the transfer destination determination unit 54 determines whether the identifier extracted in step S1102 is included in the transfer destination data stored in the transfer destination storage unit 55 (step S1103).

In the present example, as shown in FIG. 9B, the identifier of the message set to which the first message 103 belongs is included in the transfer destination data 121 stored in the transfer destination storage unit 55 in step S1105 in the message set management process in sequence step S610. Note that as described above, the identifier of the message set associated with the first message 101 is identical to the identifier of the message set associated with the second message 103. Therefore, in the message set management process in sequence step S616, the determination in step S1103 is made affirmatively, and thus the process proceeds to step 1107. In step S1107, according to data described in a row 122 in the transfer destination data 121 shown in FIG. 9B, the transfer destination determination unit 54 determines the client 3 as the transfer destination of the message.

Thus, when the destination of the second message is the same as the destination of the first message and when the identifier assigned to the second message corresponds to the identifier assigned to the first message, the transfer destination determination unit 54 determines the transfer destination of the second message as follows. That is, when the second message is received, if the second message is addressed to identification information of the user 1 and if the second message is assigned with an identifier corresponding to the identifier assigned to the first message, then the transfer destination determination unit 54 selects the client indicated by the data stored in the transfer destination storage unit 55 as the transfer destination of the second message. Note that the client indicated by the data stored in the transfer destination storage unit 55 is the client determined as the destination of the first message by the transfer destination determination unit 54. Note that in a case where the identifier of the second message corresponds to the identifier of the first message, the transfer destination determination unit 54 may transfer the second message to the same transfer destination of the first message regardless of the destination address of the second message. That is, the client that issues the image capture command may be different from the client that issues the captured image transmission command.

Next, in step S1109, a determination is performed as to whether the client determined as the transfer destination is in a state in which it can receive the message. The determination as to whether the transfer destination client can receive the message is made by the message set management unit 53 by issuing inquiry to the transmission unit 51 as to the presence state of the client 3. In a case where the transfer destination client is in a state in which it can receive the message (that is, if the answer to step S1109 is YES), the process proceeds to step S1106. In step S1106, the message is transferred to the determined transfer destination. In the present example, the client 3 remains in the same presence state since the login in sequence step S601, and thus it is determined that the client 3 can receive the message and the process proceeds to step S1106. Thus, the message set management process in sequence step S616 is complete. Next, in sequence step S617, the server 6 transmits the second message 103 to the client 3.

On the other hand, in a case where the message set management unit 53 determines in step S1109 that the transfer destination client is in a state in which it cannot receive the message (that is, if the answer to step S1109 is NO), the process proceeds to step S1110. In step S1110, an error message is returned to the sender of the message (the client 5 in this specific case) to notify that the second message 103 has failed to be transferred, and the message set management process is ended. The client cannot receive the message, for example, when the user to which the message is addressed has logged out of the transfer destination client, or when the client is set not to receive the message although the user is still logging in to the client. Note that the inability to receive the message can occur in other situations. It may be allowed to properly define situations in which it is impossible to receive messages.

As described above, in the message transfer system according to the present embodiment, when the client determined as the transfer destination of the second message is in a state in which it cannot receive the message, transmission of the second message is not performed. Thus, it is possible to prevent the message from being transmitted against the intention of the user. Furthermore, in the message transfer system according to the present embodiment, when the client determined as the transfer destination of the second message is in a state in which it cannot receive the message, an error message is transmitted to the client that is the sender of the second message to inform that the second message has failed to be transferred. Thus, the user can know that the second message has failed to be transferred, which leads to an increase in usability of the system.

Next, in sequence step S618, on receiving the second message 103 from the server 6, the client 3 returns a message to the client 5 to notify that the second message 103 has been received. In this specific example, the second message indicates that the captured image data should be transmitted to the client 5 that is the sender of the second message, and thus the client 3 transmits the captured image data to the client 5 together with the message indicating that the second message has been received.

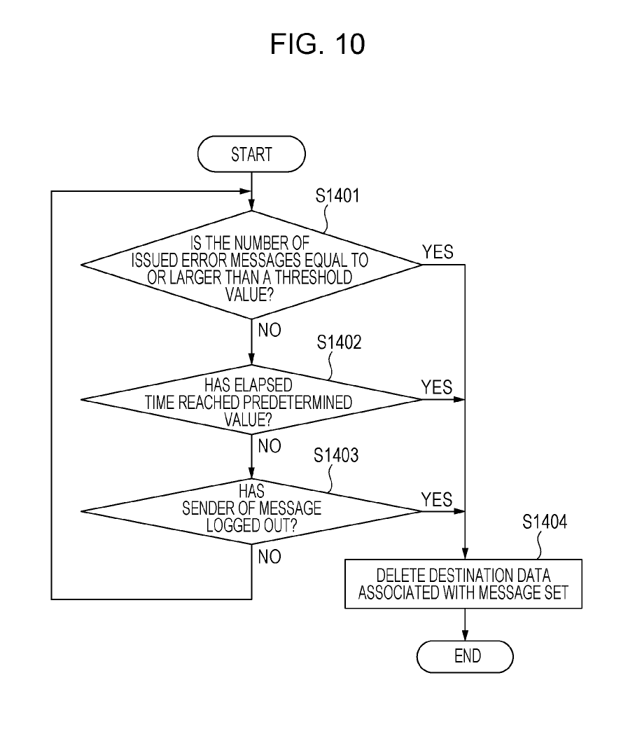

Finally, a process of discarding the transfer destination data is described. In the present embodiment, the message set management unit 53 of the server 6 discards the transfer destination data by executing a monitoring routine on each data element of the transfer destination data 121 as shown in a flow chart of FIG. 10, in parallel with and independently of the message set management process described above with reference to FIG. 8.

In step S1401, the message set management unit 53 determines whether the transmission of the error message in step S1110 has been performed as many times as a predetermined threshold number of times or more. If the error message has been transmitted as many times as the predetermined threshold number of times (five times, for example) or more, related data elements are deleted from the transfer destination data (step S1404).

In step S1402, the message set management unit 53 monitors whether any member message of a message set has not been received in a period of time equal to or longer than a threshold value (5 minutes, for example). In a case where no member message is received in the period of time equal to or longer than the threshold value (that is, if the answer to step S1402 is YES), the message set management unit 53 deletes the related data elements from the transfer destination data (step S1404).

In step S1403, the message set management unit 53 checks the transmission unit 51 to monitor whether the client that is the sender of the message is in the login state. In the case where the client that is the sender of the message has logged out, related data elements are deleted from the transfer destination data (step S1404).

Thus, by deleting data elements from the transfer destination data by executing the monitoring routine shown in FIG. 10, it is possible to automatically delete data elements that are no longer necessary in the transfer destination data.

Thus, the sequence step shown in FIG. 4 is performed in the above-described manner. In the present embodiment, via the message set management process (sequence step S608 and sequence step S610), the transfer destination client of the second message 103 is set to be the same as the transfer destination client of the first message 101, i.e., the client 3. Thus, as described above, a plurality of messages used as a whole for a particular purpose can be delivered to the same client regardless of a change in priority or the like used to determine the transfer destination of messages.

### Other Embodiments

The present invention may also be embodied as follows. For example, the client 5 notifies a message server 6 that transmission of a message set is started. In response to the start of the transmission of the message set, the server 6 starts issuing an identifier for the message set. That is, in this embodiment, in contrast to the first embodiment described above in which identifiers of message sets are issued by the message set management unit 42 of the client 5, the identifiers are issued by the message set management unit 53 of the server 6. In this embodiment, clients do not need to manage message IDs, and thus it is possible to simplify program modules of clients. This feature provides an advantage in particular when the technique according to the embodiment of the invention is applied to an electronic device with poor hardware resources.

In the first embodiment described above, it is assumed by way of example that messages are transmitted using XMPP. Note that transmission of messages may be performed using other call control protocols such as SIP (Session Initiation Protocol). As with XMPP, SIP defines a procedure that allows a server to handle a situation in which there are two or more candidates for a transfer destination client for a message addressed to a user name.

The present invention may also be practiced by performing a process described below. That is, software (program) for realizing functions of the embodiments described above is supplied to a system or an apparatus via a network or via a storage medium, and a computer (or a CPU, an MPU, or the like) in the system or the apparatus reads the program and executes it.

Aspects of the present invention can also be realized by a computer of a system or apparatus (or devices such as a CPU or an MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-273906 filed Dec. 8, 2010, which is hereby incorporated by reference herein in its entirety.

What is claimed is:

1. A transfer apparatus configured such that when the transfer apparatus receives a message addressed to a destination designated by identification information of a user using one or more clients, the transfer apparatus transfers the received message to one of the clients used by the user corresponding to the identification information, the transfer apparatus comprising:
a memory; and
a processing unit, wherein the processing unit is configured to:
register one or more clients used by the user;
determine a client to which the received message is to be transferred such that in a case where a plurality of clients used by the user corresponding to the identification information to which the received message is addressed are included in the registered clients, one of the clients used by the user is selected as the client to which the received message is to be transferred,
wherein when a first message assigned with an identifier and addressed to the identification information of the user using the plurality of clients is received, processing unit stores data indicating the determined client as a client to which the first message is to be transferred in the memory,
wherein when a second message is received, if the second message is assigned with an identifier corresponding to the identifier assigned to the first message addressed to the identification information and if the second message is addressed to the identification information of the user using the plurality of clients, the processing unit determines the client indicated by the data stored in the memory as a client to which the second message is to be transferred.

2. The transfer apparatus according to claim 1, wherein in a case where the client determined as the transfer destination of the second message is in a state in which the client cannot receive the second message, transferring of the second message is not performed and an error message is transmitted to a sender of the second message indicating that the second message failed to be transferred.

3. The transfer apparatus according to claim 1, wherein when the message addressed to the identification information of the user using the plurality of clients is received, if the plurality of clients used by the user are included among the registered clients but the received message has no identifier assigned thereto, then the processing unit is further configured to select one of the registered clients according to priority of the plurality of clients used by the user and determine the selected client as the client to which the received message is to be transferred.

4. A message transfer system configured such that when the message transfer system receives a message addressed to a destination designated by identification information of a user using one or more clients, the message transfer system transfers the received message to one of the clients used by the user corresponding to the identification information, the message transfer system comprising:
a memory; and
a processing unit, the processing unit configured to:
register the one or more clients used by the user;
determine a client to which the received message is to be transferred such that in a case where a plurality of clients used by the user corresponding to the identification information to which the received message is addressed are included in the registered clients, one of the clients used by the user is selected as the client to which the received message is to be transferred;
assigning an identifier to the message,
wherein when a first message having an identifier assigned thereto and addressed to the identification information of the user using the plurality of clients is received, the processing unit stores data indicating a determined client as a client to which the first message is to be transferred in the memory,
wherein when a second message is received, if the second message is assigned with an identifier corresponding to the identifier assigned to the first message and if the second message is addressed to the identification information of the user using the plurality of clients, then the processing unit determines the client indicated by the data stored in the storage unit as a client to which the second message is to be transferred.

5. The message transfer system according to claim 4, wherein when the message addressed to the identification information of the user using the plurality of clients is received, if the plurality of clients used by the user are included in the registered clients but the received message has no identifier assigned thereto, then the processing unit selects one of the registered clients according to priority of the plurality of clients used by the user and determines the selected client as the client to which the received message is to be transferred.

6. A method of transferring a message addressed to a destination designated by identification information of a user using one or more clients such that the message is transferred to one of the clients used by the user corresponding to the identification information to which the message is addressed, the method comprising:
registering one or more clients used by the user;
determining a client to which the received message is to be transferred such that in a case where a plurality of clients used by the user corresponding to the identification information to which the received message is addressed are included in the registered clients, one of the clients used by the user is selected as the client to which the received message is to be transferred; and
storing data associated with a client such that when a first message assigned with an identifier and addressed to the identification information of the user using the plurality of clients is received, data is stored to indicate the determined client as a client to which the first message is to be transferred,
wherein when a second message is received, if the second message is assigned with an identifier corresponding to the identifier assigned to the first message addressed to the identification information and if the second message is addressed to the identification information of the user using the plurality of clients, then the client indicated by the stored data is determined as a client to which the second message is to be transferred.

7. The method according to claim 6, wherein when the message addressed to the identification information of the user using the plurality of clients is received, if the plurality of clients used by the user are included in the registered clients but the received message has no identifier assigned thereto, then one of the clients used by the user is selected according to priority of the plurality of clients used by the user and the selected client is determined as a client to which the received message is to be transferred.

8. A computer-readable storage medium storing a program that causes a computer to execute a process of transferring a message addressed to a destination designated by identification information of a user using one or more clients such that the message is transferred to one of the clients used by the user corresponding to the identification information to which the message is addressed, the process comprising:
registering one or more clients used by the user;
determining a client to which the received message is to be transferred such that in a case where a plurality of clients used by the user corresponding to the identification information to which the received message is addressed are included in the registered clients, one of the clients used by the user is selected as the client to which the received message is to be transferred; and
storing data associated with a client such that when a first message assigned with an identifier and addressed to the identification information of the user using the plurality of clients is received, data is stored to indicate the determining client as a client to which the first message is to be transferred,
wherein when a second message is received, if the second message is assigned with an identifier corresponding to the identifier assigned to the first message addressed to the identification information and if the second message is addressed to the identification information of the user using the plurality of clients, then the client indicated by the stored data is determined as a client to which the second message is to be transferred.

9. The computer-readable storage medium storing the program according to claim 8, wherein when the message addressed to the identification information of the user using the plurality of clients is received, if the plurality of clients used by the user are included in the registered clients but the received message has no identifier assigned thereto, one of the clients used by the user is selected according to priority of the plurality of clients used by the user and the selected client is determined as a client to which the received message is to be transferred.
